(19) United States
(12) Patent Application Publication
(10) Pub. No.: US 2010/0188851 A1
(43) Pub. Date: Jul. 29, 2010

(54) Lighting Retrofit

(76) Inventor: John Timothy Sims, Bainbridge, GA (US)

Correspondence Address: American Bandit Inc., P.O. Box 251, 896 Colquitt Hwy., Bainbridge, GA, 39818, US

(21) Appl. No.: 12/360,915

(22) Filed: Jan. 28, 2009

(51) Int. Cl. F21V 21/00

(52) U.S. Cl. 362/260

(57) ABSTRACT

A lighting fixture retrofit comprised of a reflector, light bulb receptacles, receptacle covers and a device for attachment to pre existing light fixtures.

Of which the following is a specification.

A lighting retrofit to up grade 4 foot and 8 foot florescent light fixtures to a more energy efficient state of operation. This is accomplished by the combination use of a standard lamp holder, a reflector, and mounting hardware referred to as a hanger clip. The reflector is formed in a die in a press brake or any suitable metal forming device to achieve a profile as is shown in FIG. 1. of the drawings. The purpose of this profile design is for the fixture to adapt around existing fixtures and not to be entrapped into the existing mounting provisions and also to achieve superior strength. Another reason for this profile is in the event the fixture is to be flush mounted there will be adequate space for wiring.

The standard lamp holders mounted on this reflector give the user the option to replace the existing florescent tubes with more efficient florescent bulbs that are available today and that do not require specialized bulbs or electricians to maintain. The ability to apply these new style bulbs and the reflector that they are mounted on in there respective retrofit application is made possible by the profile of the reflector and the hanger clip design.

The hanger clip ( FIG. 3 and 3A in the drawings) is part of the attachment method that allows the retrofit fixture to be applied in many different applications. It is possible for this fastening device (hanger clip ) to mechanically attach to a wide range of variables in pre existing fixtures because of the inventors choice of fabrication materials and the specific spacing. of the load bearing portion of the hanger clip.

The hanger clip is formed to exacting specifications in machines designed to form wire and other small diameter material with small radius bends. The hanger clip also has provisions in it's design that allows the installer to suspend the retrofit fixture from the existing fixture. This allows the installer two hands free to make wire connections remove old components and ease the installation process.

On the opposite end of the fixture from the hanger clip is the locking nut that secures the fixture to the pre existing fixture housing or frame. The position of this locking nut in the retrofit fixture has been made variable to aid the accommodation of many different retrofit applications.

To install the retrofit fixture one would disconnect the power source supplying the current fixture, remove the standard 4 ft. or 8 ft. florescent bulbs, remove the ballast or transformer covers. The ballast or transformer that was used with the 4 ft. and 8 ft. bulbs is no longer required and it's removal is optional. Hang the retrofit fixture into the corresponding holes or slots in the existing frame, make the necessary wire connections from the pre-existing power supply, fully engage the hanger clips in there respective position and bring fixture to the closed position and secure using the variable position locking nut, re-connect power supply.

Now the old fixture can accept the newer non-specialized high efficiency screw in type Edison Base florescent bulbs which are readily available and can meet many different lighting requirements.

### TECHNICAL FIELD

The present invention relates generally to fluorescent lighting and more specifically to standardized four feet and eight feet length fluorescent fixtures, commonly known as strip lights wherein the four and eight feet fixtures are retro fitted by means of newly invented hardware to accommodate more efficient lighting and to maximize their use.

### BACKGROUND OF THE INVENTION

The cost of energy and the need to conserve it on a local and national level cause concern for the viability for our energy future. In spite of the fact that there are more efficient sources of lighting available today many find it inconvenient from a time and financial viewpoint to upgrade. This is mainly due to the fact that most of the lighting systems are hard wired with permanent mounting and would require substantial effort to update even if the per unit cost was affordable. In most cases it cost more to repair these existing fixtures than purchasing new ones like them but because of the hardships involved in replacing them most choose to repair with obsolete components at a higher cost and remain at a lower energy and lighting efficiency.

Therefore it is readily apparent that there is a need for a lighting retrofit that will accommodate existing permanently mounted fixtures and existing wiring and that will increase the energy and light efficiency without difficulty and will be an attractive option.

### BRIEF SUMMARY OF THE INVENTION

Briefly described in a preferred embodiment, the present invention overcomes the above mentioned disadvantages and meets the recognized need for such a device by providing a retro lighting fixture that is easily installed on existing lighting and that takes advantage of more efficient light sources.

For Example: The eight feet length fluorescent fixtures which are in common use have many variables in design. One aspect that is not variable is the 8 ft. bulb. Although there are many variables around the bulb, the frame for these bulbs has had to remain within certain parameters to accommodate the bulb which has remained an industry standard. The components of many of the common 8 ft. fixtures or lighting strips as they are called, consist of the frame (or housing), a transformer (or ballast), frame or housing covers and bulbs. The lighting retrofit utilizes reflectors in place of the covers and has overcome mounting to existing fixtures by design of special hanger clips and the relocation of mounting holes within the reflector. The reflector incorporates two or more standard lighting sockets that will utilize the more energy efficient screw in type fluorescent bulbs sold in supply stores. The mounting design, electrical hardware construction and the reflector combine to achieve superior lighting and ease of installation at reduced energy cost while still utilizing the existing frame, wiring and mounting of the old fixture.

The advantages to this retrofit design include utilizing existing wiring and mounted components, increased efficiency from the reflector, the ability to use newer style bulbs as well as eliminating maintenance that incorporated specialized bulbs and transformers that operate at higher cost.

### BRIEF DESCRIPTION OF THE DRAWINGS

FIG. 1 is a profile view of the preferred embodiment of the retro light fixture.

FIG. 1-A is a 45 degree bend that extends the length of the profile.

FIG. 1-B is a 90 degree bend that extends the length of the profile.

FIG. 1-C is a 45 degree bend that extends the length of the profile.

FIG. 2 is a perspective view of the back or mounting side of the retro light fixture.

FIG. 2-A is a perspective view of hole relocation and elongation.

FIG. 3 is a side view of the mounting hanger clips.

FIG. 3-A is a perspective view of the mounting hanger clips

FIG. 4 is a comparison of different mounting specifications.

### DETAILED DESCRIPTION OF THE DRAWINGS

For a better description and understanding of the invention the detailed drawings of page 9, 10, 11 and 12 will be used for reference.

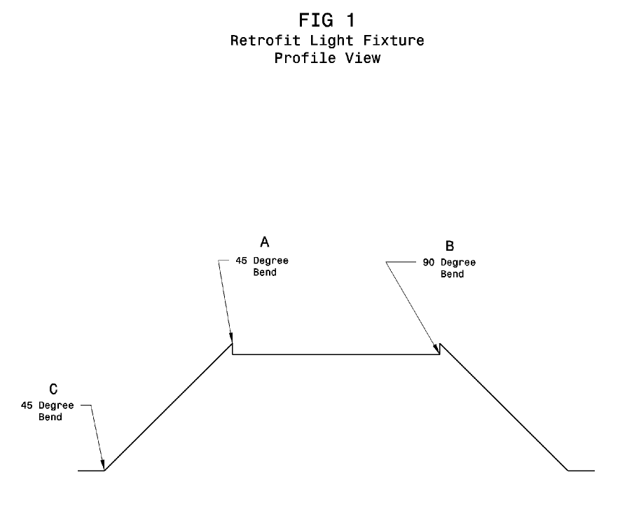

The preferred embodiment of the retro light reflector is formed in a press brake to conform to the profile of the drawing of FIG. 1. This profile has at least three distinct advantages for the inventors purpose. By incorporating bends into the length of the profile (FIGS. 1-A, 1-B, 1-C) the rigidity of the reflector is greatly increased. The dimensions of the recess formed into the length of the profile (FIGS. 1-A and 1-B) allow the reflector to fit the outside diameter (O.D) of existing fixtures so as not to be trapped into the confines of existing mounting parameters of many different manufactures The dimensions of the recess (FIGS. 1-A and 1-B) in the length of the profile allows space for wiring so the reflector can be mounted on a flat surface if desired with out the possibility of entrapping wires.

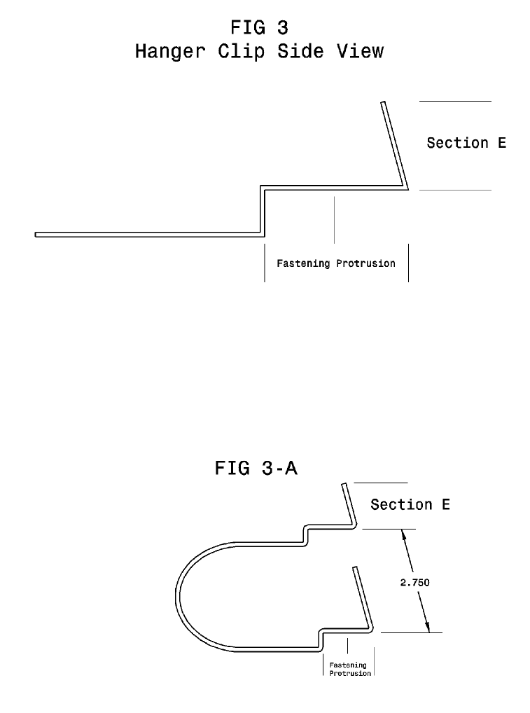

The mounting hanger clips (FIG. 3) are crucial to the versatility of the retrofit light fixture. The hanger clips are formed from a suitable profile material such as round, rectangular or square or any other profile material that can stay within the confines of the inventors design. Normally these clips would be formed in machines dedicated to the sole purpose of forming wire and other profiles.

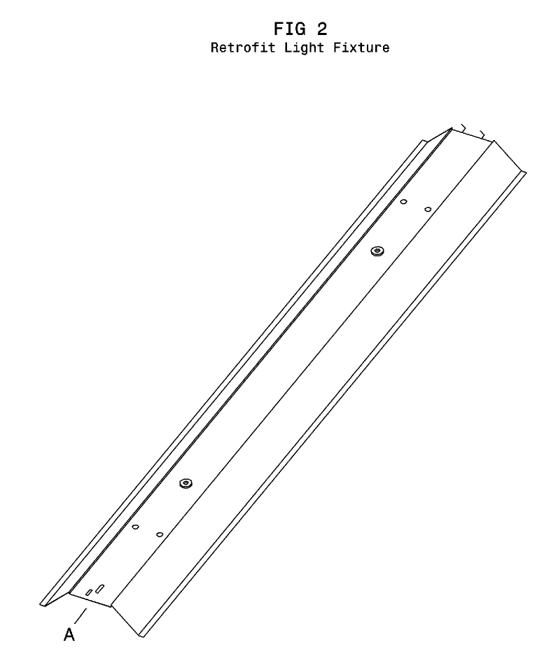

The hanger clips are formed to exacting specifications and from a specific profile material for reasons that will become apparent. The ballast covers on most 4 and 8 feet fluorescent light strips are mounted and secured in a fashion that allows removal to service the fixture. A standardized method of securing this cover to the frame includes some type of hangers at one end that interlock into corresponding holes or slots in the frame of the fixture and with a locking nut securing the opposite end with a corresponding hole in the frame of the fixture for this purpose. As would be imagined the location of the hanger clips on the ballast cover as well as the location of the locking nut vary from manufacture to manufacture. Since the retrofit fixture is to utilize the existing frame of various fixtures with these variations this problem had to be overcome By utilizing a profile material with a width not to exceed 0.250 inch to form the hanger clips and precisely calculating the spacing of the hanger clips for the retrofit lighting fixture the inventor has overcome the obstacle of the many variations in existing frame designs. Also the many variations in the location of the hole for the locking nut in various frames has been compensated for by relocation and elongation (FIG. 2-A) of this hole position in the inventors design.

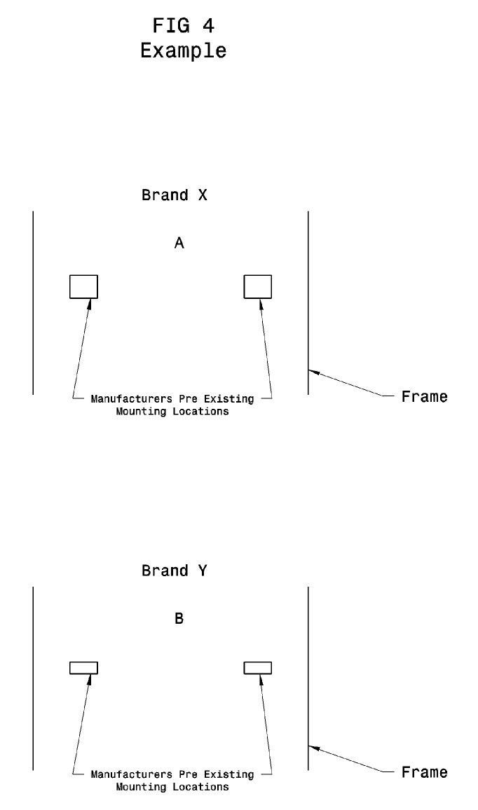

Referring to the drawing of FIG. 4 gives a good example of the variations that make it difficult to design upgrade components for brand X and brand Y lighting fixtures. The spacing and the width of the hanger clips of brand X make it impossible to interchange ballast covers to brand Y. This is only one of many variations. In FIG. 4-A brand X has it's holes centered in the frame with the hole centers at approximately 2.5 inches and the hole width being approximately 0.5 inches. The corresponding hanger clips on the ballast cover are on 2.5 inch centers with the width of the clip being approximately 0.375 inches

In FIG. 4-B brand Y has it's holes centered in the frame but with it's hole centers at 3.00 inch and the hole width being approximately 0.525 inches and the width of the hanger clips on the ballast cover being approximately 0.460 inches.

As is apparent the two covers will not interchange, as is frequently the case with the many variations in manufacturing and design.

The inventor has overcome these variables by using the fore mentioned profile materials of a specific size and at a specific location for the hanger clips in the place of the standard sheet metal. This lends strength to the hanger clips for it's new role as it is combined into the fixture And because of the greatly reduced width, the hanger clips can now be placed in a generic location that will accommodate a wide range of manufacturing variations.

Another practical feature of the inventors design is the ability of the hanger clips to hold the fixture in the vertical position so as to provide the installer with two hands to work with during the installation process. Section E of the hanger clips of FIG. 3 is used solely to hang the fixture for ease of installation. The installer would simply insert section E of FIG. 3 into the corresponding holes in the fixture frame and allow the fixture to swing downward to hang vertically.

The hanger clips of this invention are installed so as to be removable which has applications other than retro fitting existing fixtures. For example, used as a surface mount application of the retrofit light fixture the hanger clips would not be necessary and could be easily removed. Also the hanger clips may be removed and changed to another design of clips to accommodate for yet another variation in manufacturing design.

To install the retro fit lighting fixture the installer must first disconnect the power source going to the fixture, remove the old bulbs, remove the ballast covers and remove the ballast or transformer. These parts are no longer needed. Next the installer would hang the retrofit fixture by section E of the hanger clips in FIG. 3, connect the power to the retrofit fixture utilizing the pre existing wires, fully engage the hanger clips in their respective positions, close the cover/reflector and secure with the adjustable position locking nut. The retro lighting fixture has 2 or more standard light sockets. These sockets are enclosed in removable covers. If the retro fixture is to be mounted in an application other than a light strip retrofit the socket covers may be removed so that electrical connections may be made inside containment as per local and state electrical codes.

What is claimed is:

1. A light fixture capable of being retrofit into an existing light fixture.

2. Light fixture of claim 1 further comprising hardware with which to mount to the existing fixture.

3. The mounting hardware of claim 2 which includes a pair of clips which can attach a cover or reflector to the light fixture frame of multiple light fixture manufactures.

4. The mounting hardware clips of claim 3 further comprising the shape specified within this patent application and drawings.

5. The mounting hardware clip of claim 3 where the clip is formed from a non flat material.

6. A light fixture of claim 1 further comprised of a reflector, light bulb receptacles and a means for attachment to an existing 4 feet long and 8 feet long fluorescent light strip.

7. The light fixture of claim 1 further comprising a retro fitting reflector for an existing light strip with a width of no less than 4.00 inches and no greater than 4.375 inches.

8. A light fixture of claim 6 which allows the light fixture to perform at a higher efficiency.

9. A light fixture comprised of a reflector, light bulb receptacles and a means for attachment to an existing florescent light strip with a frame width of no less than 4.00 inches and no greater than 4.375 inches to render the existing fixture capable to perform at higher efficiency.

10. The retro light fixture of claim 1 further comprising a means to make generic the attachment parameters of existing fixtures.

11. The retro light fixture of claim 9 further comprising a means to make an attachment to existing light fixtures generic wherein said width of the profile of the attachment apparatus will not be less than 0.050 inch or exceed in width 0.250 inch and the mechanical fastening protrusion section of the device will not be spaced further apart than 3.00 inches or closer together than 2.500 inches

12. The retro light fixture of claim 1 further comprising a means to couple into an existing light fixture for the purpose of hanging freely so as to suspend itself while not being fully engaged or in the closed position.

13. The retro light fixture of claim 9 further comprising an attachment method referred to as hanger clips, wherein said profile diameter of hanger clips will not be less than 0.050 inch in diameter or exceed in diameter 0.250 inch and the mechanical fastening protrusions section of the hanger clips will not be spaced further apart than 3.00 inches or closer together than 2.500 inches.

14. The light fixture of claim 1 further comprising an attachment method referred to as hanger clips, wherein said profile diameter of hanger clips will not be less than 0.050 inch in diameter or exceed in diameter 0.250 inch and the mechanical fastening protrusions of the hanger clip will not be spaced further apart than 3.00 inches or closer together than 2.500 inches.

15. A lighting fixture with an attachment device to provide a means to make an attachment to existing light wherein said profile diameter of the attachment device will not be less than 0.050 inches in diameter or exceed in diameter 0.250 inches and the mechanical fastening protrusions section of the device will not be spaced further apart than 3.00 inches or closer together than 2.500 inches.

16. The lighting fixture of claim 15 wherein attachment device has provisions to couple into a light fixture for the purpose of hanging freely so as to suspend itself while not being fully engaged.

17. The lighting fixture of claim 9 wherein attachment device has provisions to couple into a light fixture for the purpose of hanging freely so as to suspend itself while not being fully engaged.
